(19) United States
(12) Patent Application Publication
(10) Pub. No.: US 2017/0161114 A1
(43) Pub. Date: Jun. 8, 2017

(54) METHOD AND APPARATUS FOR TIME-BASED SCHEDULING OF TASKS

(71) Applicant: Advanced Micro Devices, Inc., Sunnyvale, CA (US)

(72) Inventors: Walter B. Benton, Austin, TX (US); Steven K. Reinhardt, Bellevue, WA (US)

(73) Assignee: Advanced Micro Devices, Inc., Sunnyvale, CA (US)

(21) Appl. No.: 14/962,784

(22) Filed: Dec. 8, 2015

(51) Int. Cl. G06F 9/50

(52) U.S. Cl. CPC G06F 9/5038

(57) ABSTRACT

A computing device is disclosed. The computing device includes an Accelerated Processing Unit (APU) including at least a first Heterogeneous System Architecture (HSA) computing device and at least a second HSA computing device, the second computing device being a different type than the first computing device, and an HSA Memory Management Unit (HMMU) allowing the APU to communicate with at least one memory. The computing task is enqueued on an HSA-managed queue that is set to run on the at least first HSA computing device or the at least second HSA computing device. The computing task is re-enqueued on the HSA-managed queue based on a repetition flag that triggers the number of times the computing task is re-enqueued. The repetition field is decremented each time the computing task is re-enqueued. The repetition field may include a special value (e.g., −1) to allow re-enqueuing of the computing task indefinitely.

### TECHNICAL FIELD

The disclosed embodiments are generally directed to time-based scheduling of tasks in a computing system.

### BACKGROUND

Many computing operations need to be performed periodically, such as keep-alive messages, reporting for health monitoring, and performing checkpoints. Other possibilities include periodically performing calculations that are used by cluster management software such as system load average, calculation of power metrics, and the like. In addition to fixed period processing, a process may want to schedule task execution at some random time in the future, such as for random time-based statistical sampling.

In order to provide a solution to this problem, periodic process execution, such as that provided by the cron and atd facilities in UNIX and LINUX, allow for time-based scheduling of processes. These solutions involve significant overhead in process creation, memory usage and the like and operate through the operating system (OS) for process creation and termination and are limited to standard central processing unit (CPU) processing. Therefore a need exists for a method and apparatus for time-based scheduling of tasks in a computer system directly by a task without the overhead of going through the OS for process creation and termination.

### SUMMARY OF EMBODIMENTS

A computing device is disclosed. The computing device includes an Accelerated Processing Unit (APU) including at least a first Heterogeneous System Architecture (HSA) computing device and at least a second HSA computing device, the second computing device being a different type than the first computing device, and an HSA Memory Management Unit (HMMU) allowing the APU to communicate with at least one memory. The at least one computing task is enqueued on an HSA-managed queue that is set to run on the at least first HSA computing device or the at least second HSA computing device. The at least one computing task is enqueued using a time-based delay queue wherein the time-base uses a timer and is executed when the delay reaches zero. The at least one computing task is re-enqueued on the HSA-managed queue based on a repetition flag that triggers the number of times the at least one computing task is re-enqueued. The repetition field is decremented each time the at least one computing task is re-enqueued. The repetition field may include a special value (e.g., −1) to allow re-enqueuing of the at least one computing task indefinitely.

### BRIEF DESCRIPTION OF THE DRAWINGS

A more detailed understanding may be had from the following description, given by way of example in conjunction with the accompanying drawings wherein:

FIG. 1 is a block diagram of a processor block, such as an exemplary APU;

FIG. 2 illustrates a homogenous computer system;

FIG. 3 illustrates a heterogeneous computer system;

FIG. 4 illustrates the heterogeneous computer system of FIG. 3 with additional hardware detail associated with the GPU processor;

FIG. 5 illustrates a heterogeneous computer system incorporating at least one timer device and a multiple queue per processor configuration;

FIG. 6 illustrates a computer system with queues populated by other processors;

FIG. 7 illustrates an Heterogeneous System Architecture (HSA) platform;

FIG. 8 illustrates a diagram of the queuing between and among throughput compute units and latency compute units;

FIG. 9 illustrates a flow diagram of a time-delayed work item; and

FIG. 10 illustrates a flow diagram of the periodic reinsertion of a task upon a task queue.

### DETAILED DESCRIPTION

The HSA platform provides mechanisms by which user-level code may directly enqueue tasks for execution on HSA-managed devices. These may include, but are not limited to, Throughput Compute Units (TCUs), Latency Compute Units (LCUs), DSPs, Fixed Function Accelerators, and the like. In its original embodiment, a user process is responsible for enqueuing tasks onto HSA managed tasks queues for immediate dispatch to HSA-managed devices. This extension to HSA provides a mechanism for tasks to be enqueued for execution at a designated future time. Also, this may enable periodic re-enqueuing such that a task may be issued once, but then be repeatedly re-enqueued on the appropriate task queue for execution at a designated interval. The present system and method provides a service to the UNIX/Linux cron services within the context of HSA. The present system and method provides a mechanism that allows scheduling and use of computational resources directly by a task without the overhead of going through the OS for process creation and termination. The present system and method may also extend the concepts of time-based scheduling to all HSA-managed devices and not just for standard CPU processing.

A computing device is disclosed. While any collection of processing units may be used, Heterogeneous System Architecture (HSA) devices may be used in the present system and method, and an exemplary computing device includes an Accelerated Processing Unit (APU) including at least one Central Processing Unit (CPU) having at least one core, and at least one Graphics Processing Unit (GPU) including at least one HSA compute unit (H-CU), and an HSA Memory Management Unit (HMMU or HSA MMU) allowing the APU to communicate with at least one memory. Other devices may include HSA devices, such as Processing-in-Memory (PIM), network devices, and the like. At least one computing task is enqueued on an HSA-managed queue that is set to run on the at least one CPU or the at least one GPU. The at least one computing task is enqueued using a time-based delay queue wherein the time-base uses a device timer and/or a universal timer and is executed when the delay queue reaches zero, such as when a DELAY VALUE is depleted, as described herein below. The at least one computing task is re-enqueued on the HSA-managed queue based on a repetition flag that triggers the number of times the at least one computing task is re-enqueued. The repetition field is decremented each time the at least one computing task is re-enqueued. The repetition field may include a special value to allow re-enqueuing of the at least one computing task indefinitely. The special value may be negative one.

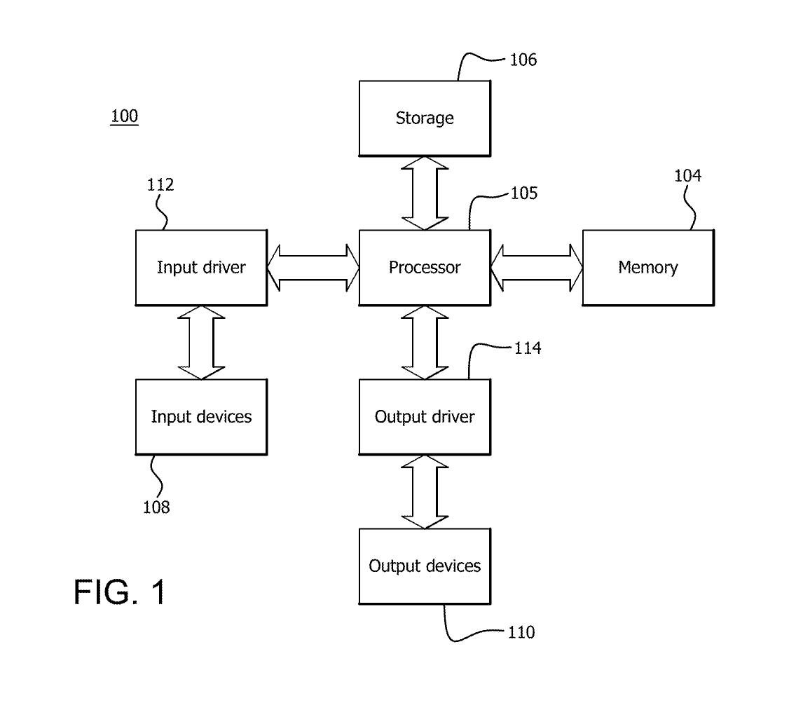

FIG. 1 is a block diagram of an example device 100 in which one or more disclosed embodiments may be implemented. The device 100 may include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 may also optionally include an input driver 112 and an output driver 114. It is understood that the device 100 may include additional components not shown in FIG. 1.

The processor 102 may include a central processing unit (CPU), a graphics processing unit (GPU), a CPU and GPU located on the same die, or one or more processor cores, wherein each processor core may be a CPU or a GPU. The memory 104 may be located on the same die as the processor 102, or may be located separately from the processor 102. The memory 104 may include a volatile or non-volatile memory, for example, random access memory (RAM), dynamic RAM, or a cache.

The storage 106 may include a fixed or removable storage, for example, a hard disk drive, a solid state drive, an optical disk, or a flash drive. The input devices 108 may include a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 may include a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present.

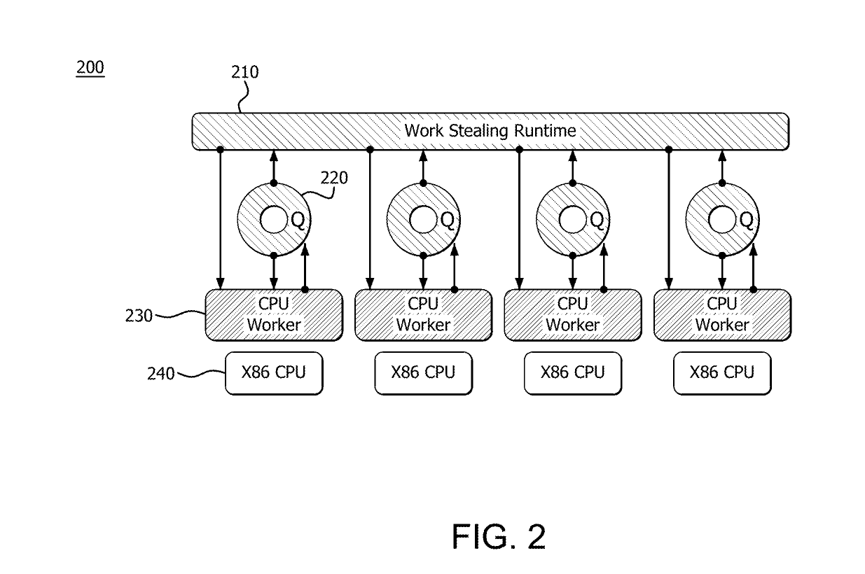

FIG. 2 illustrates a homogenous computer system 200. Computer system 200 operates with each CPU pulling a task from the task queue and processing the task as necessary. As shown in FIG. 2, there are a series of processors 240, represented as specific X86 CPUs. The processors rely on a CPU worker 230 to retrieve tasks or thread tasks to the processor 240 from queue 220. As shown there may be multiple queues 220, CPU workers 230 and CPUs 240. In order to provide load balancing and/or to direct which CPU 240 performs a given task (i.e. which queue 220 is populated with a task), runtime 210 may be used. This runtime 210 may provide load balancing across the CPUs to effectively manage the processing resource. Runtime 210 may include specific application level instructions that dictate which processor to use for processing either by using a label or by providing an address, for example. Runtime 210 may include tasks that are spawned from applications and the operating system including those tasks that select processors to be run-on. As will be discussed herein below, a timer device (not shown in this configuration although it may be applied to computer system 200) may be used to provide load balancing and queue management according to an embodiment.

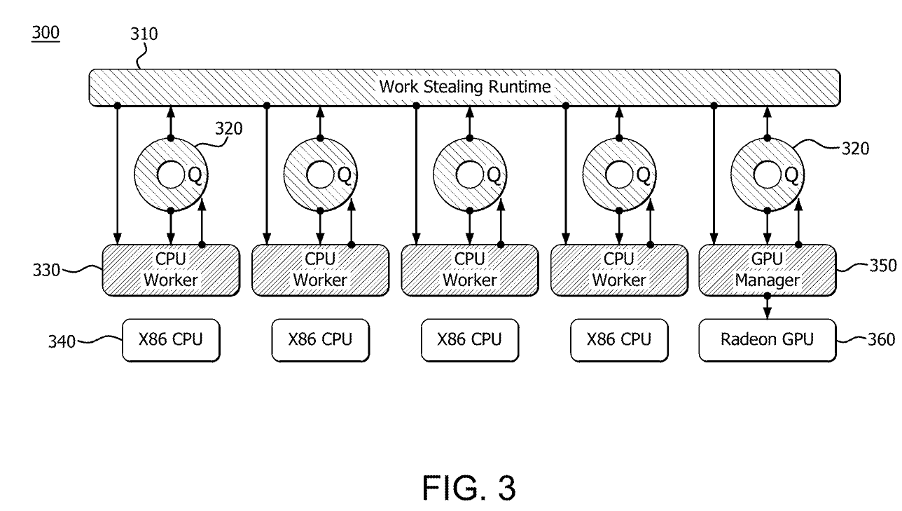

FIG. 3 illustrates a heterogeneous computer system 300. Computer system 300 operates with each CPU pulling a task from the task queue and processing the task as necessary, in a similar fashion to computer system 200. As shown in FIG. 3, there are a series of processors 340 represented as specific X86 CPUs. As in computer system 200, each of these processors 340 reply on a CPU worker 330 to retrieve tasks or thread task to the processor 340 from queue 320. As shown there may be multiple queues 320, CPU workers 330 and CPUs 340. Computer system 300 may also include at least one GPU 360 that has its queue 320 controlled through a GPU manager 350. While only a single GPU 360 is shown, it should be understood that any number of GPUs 360 with accompanying GPU managers 350 and queues 320 may be used.

In order to provide load balancing and/or to direct which CPU 340 or GPU 360 performs a given task (i.e. which queue 320 is populated with a task, runtime 310 may be used. This runtime 310 may provide load balancing across the CPUs to effectively manage the processing resource. However, because of the heterogeneous nature of the computer system 300, runtime 310 may have a more difficult task of load balancing because GPU 360 and CPU 340 may process through their respective queue 320 differently, such as in parallel vs. serial, for example, making it more difficult for runtime 310 to determine the amount of processing remaining for tasks in queue 320. As will be discussed herein below, a timer device (not shown in this configuration although it may be applied to computer system 300) may be used to provide load balancing and queue management according to an embodiment.

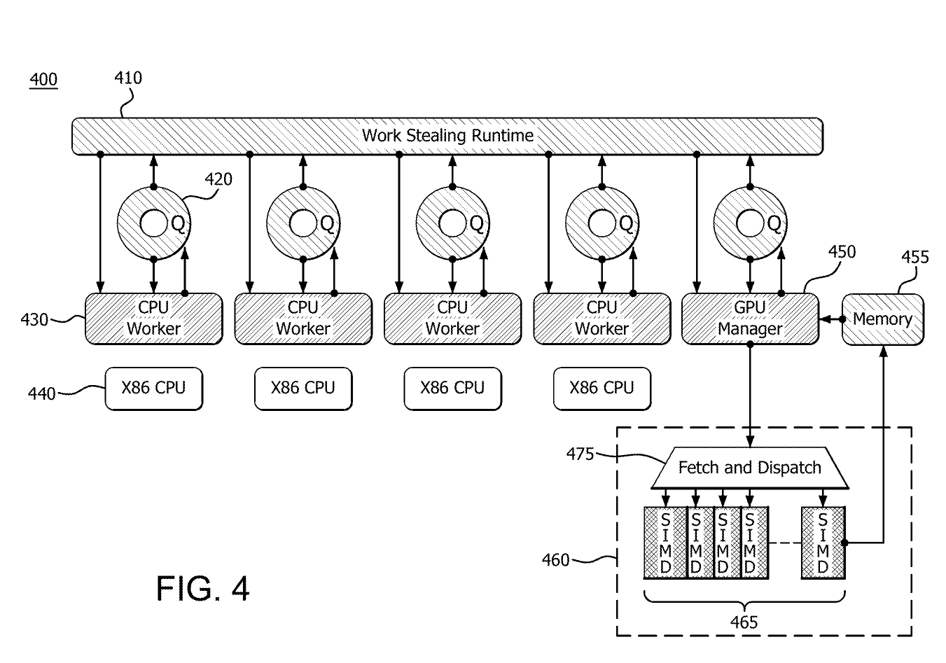

FIG. 4 illustrates the heterogeneous computer system 300 of FIG. 3 with additional hardware detail associated with the GPU processor. Specifically, computer system 400 illustrated in FIG. 4 includes computer system 400 operating with each CPU pulling a task from the task queue and processing the task as necessary, as in a similar fashion to computer systems 200, 300. As shown in FIG. 4, there are a series of processors 440 represented as specific X86 CPUs. As in computer systems 200, 300, each of these processors 440 reply on a CPU worker 430 to retrieve tasks or thread task to the processor 440 from queue 420. As shown there may be multiple queues 420, CPU workers 430 and CPUs 440. Computer system 400 may also include at least one GPU 460 that has its queue 420 controlled through a GPU manager 450. While only a single GPU 460 is shown, it should be understood that any number of GPUs 460 with accompanying GPU managers 450 and queues 420 may be used. Additional detail is provided in computer system 400 including a memory 455 associated with GPU manager 450. Memory 455 may be utilized to perform processing associated with GPU 460.

Additional hardware may also be utilized, including single instruction, multiple data (SIMD) 465. While several SIMDs 465 are shown, any number of SIMDs 465 may be used. SIMD 465 may include computers with multiple processing elements that perform the same operation on multiple data points simultaneously—there are simultaneous (parallel) computations, but only a single process (instruction) at a given moment. SIMD 465 may work on multiple tasks simultaneously, such as tasks where the entirety of the processing for GPU 460 is not needed. This may provide a better allocation of processing capabilities, for example. This is in contrast to CPUs 440 which generally operate on one single task at a time and then move to the next task. As will be discussed herein below, a timer device (not shown in this configuration although it may be applied to computer system 400) may be used to provide load balancing and queue management according to an embodiment.

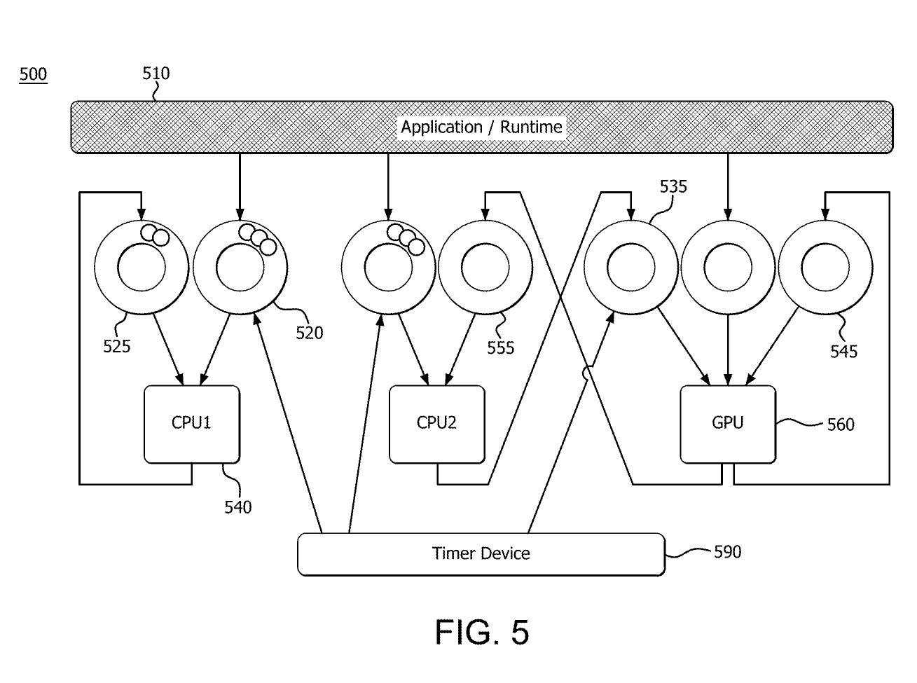

FIG. 5 illustrates a heterogeneous computer system 500 incorporating at least one timer device 590 and a multiple queue per processor configuration. As illustrated in FIG. 5, CPU1 540 may have two queues associated therewith, queue 520 and queue 525. Queue 520 may be of the type described hereinabove with respect to FIGS. 2-4, where the queue is controlled and/or populated via application/runtime 510. Queue 525 may be populated and controlled by CPU1 540, such as by populating the queue 25 with tasks that are spawned from tasks completed by CPU1 540. While two queues are shown for CPU1 540, any number of queues from application/runtime 510 and/or CPU1 540 may be used.

As is illustrated in FIG. 5, CPU2 540 may also have multiple queues 520, 555. Queue 520 again may be of the type described hereinabove with respect to FIGS. 2-4, where the queue is controlled and/or populated via application/runtime 510. Queue 555 is a conceptually similar queue to queue 525 in that queue 525 is populated by CPU 540. Queue 555 is populated by another processing unit (in this case GPU 560) other than the one that it feeds (CPU2).

As is illustrated in FIG. 5, queue 535 is populated by CPU2 540 and feeds GPU 560. Queue 545 feeds GPU 560 and is populated by GPU 560. Queue 520 feeds GPU 560 and is populated by application/runtime 510.

Also illustrated in FIG. 5 is timer device 590. Timer device 590 may create tasks autonomously from the rest of the system and in particular from application/runtime 510. As shown, timer device 590 may be able to populate queues with tasks for any one or more of the processors in the system 500. Specifically, timer device 590 may populate queues 520 to be run on CPU1 540, CPU2 540, or GPU 560. Timer device may also populate queues 525, 535, 545, 555 with tasks to be run on the processors 540, 560 for those respective queues 525, 535, 545, 555.

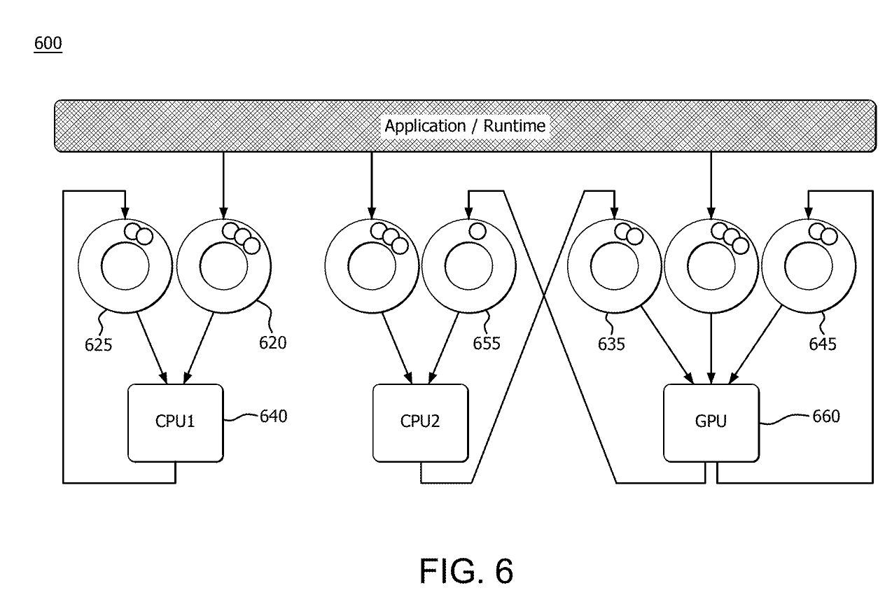

FIG. 6 illustrates a computer system 600 with queues populated by other processors. Computer system 600 is similar to computer system 500 of FIG. 5 depicting a heterogeneous computer system incorporating a multiple queue per processor configuration. As shown in FIG. 6, CPU1 640 may have two queues associated therewith, queue 620 and queue 625. Queue 620 may be of the type described hereinabove with respect to FIGS. 2-5, where the queue is controlled and/or populated via application/runtime 610. Queue 625 may be populated and controlled by CPU1 640, such as by populating the queue 625 with tasks that are spawned from tasks completed by CPU1 640. While two queues are shown for CPU1 640, any number of queues from application/runtime 610 and/or CPU1 640 may be used.

As is illustrated in FIG. 6, CPU2 640 may also have multiple queues 620, 655. Queue 620 again may be of the type described hereinabove with respect to FIGS. 2-5, where the queue is controlled and/or populated via application/runtime 610. Queue 655 is a conceptually similar queue to queue 625 in that queue 625 is populated by CPU 640. Queue 655 is populated by another processing unit (in this case GPU 660) other than the one that it feeds (CPU2).

As is illustrated in FIG. 6, queue 635 is populated by CPU2 6540 and feeds GPU 660. Queue 645 feeds GPU 660 and is populated by GPU 660. Queue 620 feeds GPU 660 and is populated by application/runtime 610.

FIG. 6 illustrates the population of each queue 620, 625, 635, 645, and 655 with tasks. In the case of queue 625 there are two tasks in the queue, although any number may be used or populated. Queue 635 is populated with two tasks, queue 645 with two tasks, and queue 655 populated with a single task. The number of tasks presented here is just exemplary as any number of tasks may be populated in a queue including zero tasks up to the number capable of being held in a queue.

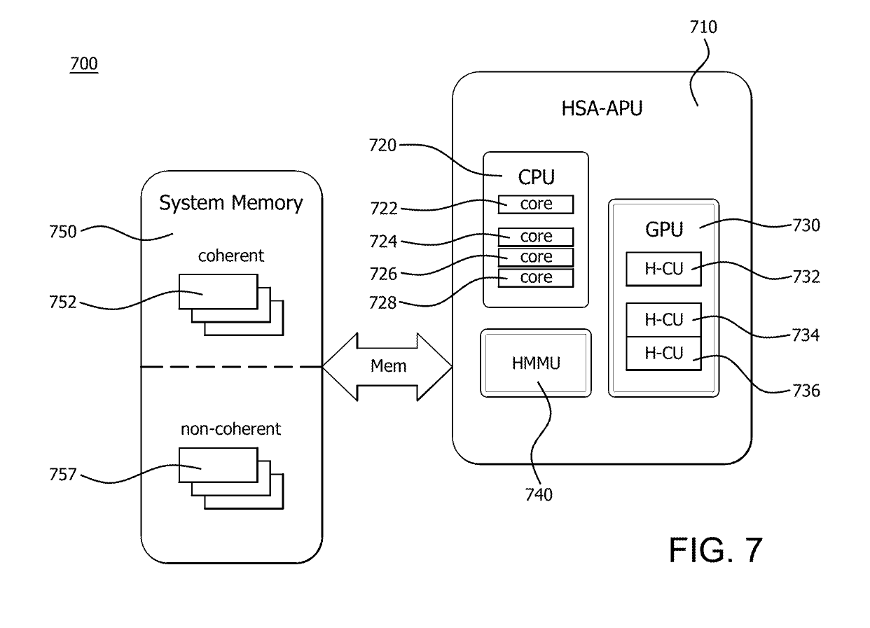

FIG. 7 illustrates a Heterogeneous System Architecture (HSA) platform 700. The HSA Accelerated Processing Unit (APU) 710 may contain a multi-core CPU 720, a GPU 730 with multiple HSA compute units (H-CUs) 732, 734, 736, and a HSA memory management unit (HMMU or HSA MMU) 740. CPU 720 may include any number of cores, with cores 722, 724, 726, 728 shown in FIG. 7. GPU 730 may include any number of H-CUs although three are shown in FIG. 7. While a HSA is specifically discussed and presented in the described embodiments, the present system and method may be utilized on either a homogenous or heterogeneous system, such as those systems described in FIGS. 2-6.

HSA APU 710 may communicate with a system memory 750. System memory 750 may include one or both of coherent system memory 752 and non-coherent system memory 757.

HSA 700 may provide a unified view of fundamental computing elements. HSA 700 allows a programmer to write applications that seamlessly integrate CPUs 720, also referred to as latency compute units, with GPUs 730, also referred to as throughput compute units, while benefiting from the best attributes of each.

GPUs 730 have transitioned in recent years from pure graphics accelerators to more general purpose parallel processors, supported by standard APIs and tools such as OpenCL and DirectCompute. Those APIs are a promising start, but many hurdles remain for the creation of an environment that allows the GPU 730 to be used as fluidly as the CPU 720 for common programming tasks including different memory spaces between CPU 720 and GPU 730, non-virtualized hardware, and so on. HSA 700 removes those hurdles, and allows the programmer to take advantage of the parallel processor in the GPU 730 as a peer to the traditional multi-threaded CPU 720. A peer device may be defined as an HSA device that shares the same memory coherency domain as another device.

HSA devices 700 communicate with one another using queues. Queues are an integral part of the HSA architecture. Latency processors 720 already send compute requests to each other in queues in popular task queuing run times like ConcRT and Threading Building Blocks. With HSA, latency processors 720 and throughput processors 730 may queue tasks to each other and to themselves. The HSA runtime performs all queue creation and destruction operations. A queue is a physical memory area where a producer places a request for a consumer. Depending on the complexity of the HSA hardware, queues might be managed by any combination of software or hardware. Hardware managed queues have a significant performance advantage in the sense that an application running on latency processors 720 can queue work to throughput processors 730 directly, without the need for any intervening operating system calls. This allows for very low latency communication between devices. With this, the throughput processors 730 device may be viewed as a peer device. Latency processors 720 may also have queues. This allows any device to queue work for any other device.

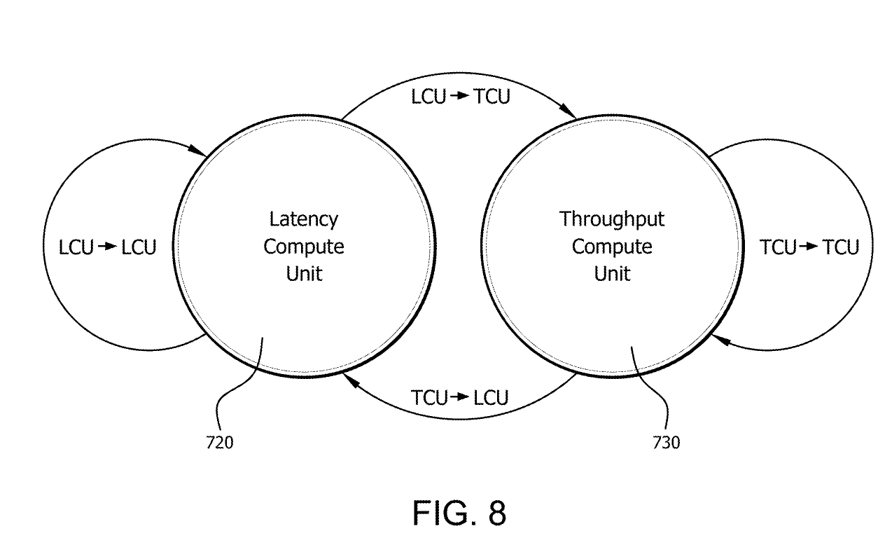

Specifically, as shown in FIG. 8, latency processors 720 may queue to throughput processors 730. This is the typical scenario of OpenCL-style queuing. Throughput processors 730 can queue to another throughput processor 730 (including itself). This allows a workload running on throughput processors 730 to queue additional work without a round-trip to latency processors 720, which would add considerable and often unacceptable latency. Throughput processors 730 may queue to latency processors 720. This allows a workload running on throughput processors 730 to request system operations such as memory allocation or I/O.

The current HSA task queuing model provides for enqueuing of a task on an HSA-managed queue for immediate execution. This enhancement allows for two additional capabilities (1) a delayed enqueuing and/or execution of a task and, (2) periodic re-insertion of the task upon a task queue.

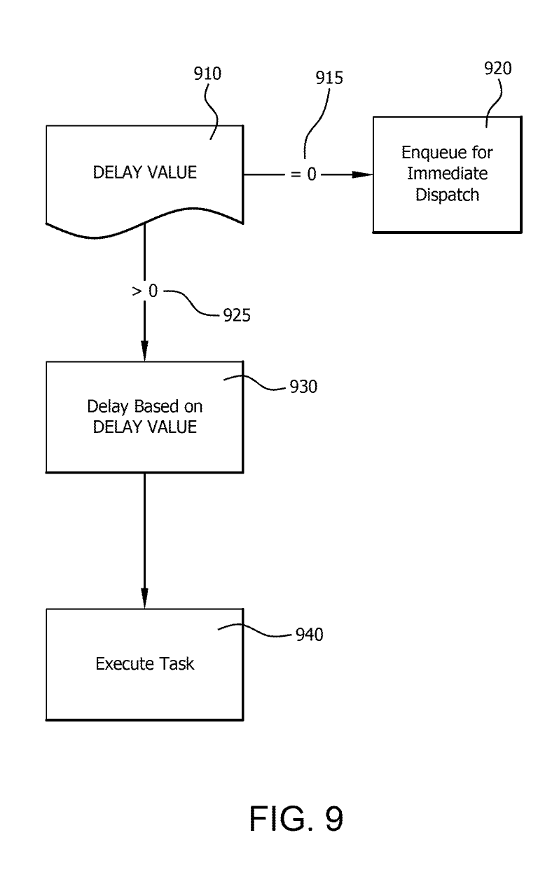

For delayed enqueuing and/or execution of a task, the HSA device 700 may utilize a timer capability that may be set to cause an examination of a time-based schedule/delay queue after a given interval. Referring now to FIG. 9, there is shown a flow diagram of a time-delayed work item. The computing device requesting scheduled task execution may enqueue the task on a standard task queue. The enqueued work item may include information to indicate whether or not this is a time-delayed work item via values in a delay field (a DELAY VALUE 910) of the work item. If the DELAY VALUE 910 is zero 915, then the work item may be enqueued for immediate dispatch 920. If the DELAY VALUE 910 is greater than zero 925, then that represents the value to use to determine the amount of time to defer task execution (delay based on DELAY VALUE) at step 930. For example, the DELAY VALUE 910 may indicate the number of ticks of the HSA platform clock by which to delay execution of the task. After the delay indicated by the DELAY VALUE 910 is depleted the task may execute at step 940.

The timer implementation may be limited to a larger time granularity than specified in the work item. In that case, the implementation may choose the rules for deciding how to schedule the task. For example, the implementation may round to the nearest time unit, or may decide to round to the next highest or next lowest time unit.

The work item information may also contain information to indicate whether or not the task is to be re-enqueued and, if so, how many times to be re-enqueued and the re-enqueue schedule policy: This may enable the periodic re-insertion of the task upon a task queue. The work item may contain a RE-ENQUEUE FLAG. If the FLAG is non-zero, then once the work item has completed execution, the FLAG may be re-scheduled based on the values of a REPETITION FIELD, a DELAY VALUE, and the re-enqueue schedule policy based on the value of a periodic FLAG.

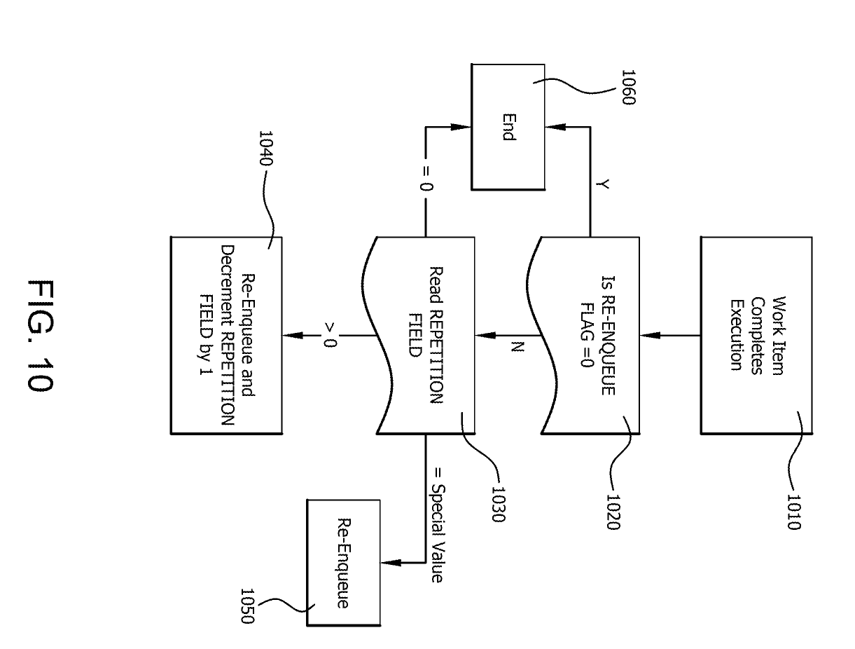

Referring now to FIG. 10, there is shown a flow diagram of the periodic reinsertion of a task upon a task queue. This flow begins with the completion of the task being executed at step 1010 thereby allowing for periodic reinsertion. The RE-ENQUEUE FLAG is examined at step 1020. If the RE-ENQUEUE is zero, then periodic reinsertion may end at step 1060. If the RE-ENQUEUE FLAG is non-zero, then the re-enqueue logic may determine the number of times to re-enqueue by examining a REPETITION FIELD at step 1030. If the REPETITION FIELD is >0, then the task is re-enqueued and the REPETITION FIELD is decremented by 1 at step 1040. When the REPETITION FIELD reaches 0, the task is no longer re-enqueued at step 1060. A repetition value of a special value, such as −1, indicates that the task will always be re-enqueued at step 1050. In this case, the REPETITION FIELD is not decremented after each task execution.

The time interval with which the task is re-enqueued is based on the value of a PERIODIC FLAG. If the FLAG is non-zero, then the task is re-enqueued for the interval in the DELAY FIELD. One optional extension is to allow for re-enqueuing with a random interval. This may support a random time-based execution. This may be useful for random-based sampling of data streams, system activity, monitored values, and the like. In order to accomplish this random-based sampling, if the PERIODIC FLAG is zero, then the interval is random rather than periodic and the re-enqueue interval is randomly chosen in the range from 0 and the value of the DELAY FIELD. In other words, the value of the DELAY FIELD is the upper bound of the delay range.

Additional facilities may be provided for such capabilities as retrieving information about scheduled tasks and canceling currently scheduled tasks. The HSA task queuing protocol may be enhanced to support these commands. Some embodiments may maintain uniqueness among tasks via task identifiers, system name and work item counter, or the like. The result of the cancel command is to remove the specified periodic task from the timer queue so that it will no longer be scheduled for execution. The present system may also return a list and status of tasks currently in the delay queue. Status can include such information as: time to next execution, re-enqueue flag value, re-enqueue count value, and interval value.

The cancel and list/status operations may also provide for privileged (e.g., root) access. This may allow system administrators as well as processes executing with sufficient privilege to query and possibly cancel time-based tasks.

The present system and method may be configured such that there is a single HSA scheduler device that is used to schedule periodic tasks on any available HSA devices in a node, rather than a scheduler integrated with each HSA device. In either the single HSA scheduler device per node, or an integrated HSA scheduler per HSA device, the interaction from the client of the task queue may be the same. That is, the HSA implementation may have a single HSA scheduler device to manage the scheduling or may have an HSA scheduler per HSA device.

It should be understood that many variations are possible based on the disclosure herein. Although features and elements are described above in particular combinations, each feature or element may be used alone without the other features and elements or in various combinations with or without other features and elements.

The methods provided may be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions and other intermediary data including netlists (such instructions capable of being stored on a computer readable media). The results of such processing may be maskworks that are then used in a semiconductor manufacturing process to manufacture a processor which implements aspects of the embodiments.

The methods or flow charts provided herein may be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A computing device, the device comprising:
a processing unit including at least a first computing device having at least one first computing device queue associated therewith, and at least a second computing device having at least one second computing device queue associated therewith; and
a timer device directly controlling the enqueuing of at least one computing task via at least one of the at least one first computing device queue and the at least one second computing device queue to reduce the overhead of using an operating system for creation and termination of the at least one computing task.

2. The device of claim 1 wherein the at least one computing task is enqueued using a time-based delay.

3. The device of claim 2 wherein the time-base uses a device timer.

4. The device of claim 2 wherein the time-base uses a universal timer.

5. The device of claim 2 wherein the at least one computing task is executed when the delay queue reaches zero.

6. The device of claim 1 wherein the first computing device comprises a latency compute unit.

7. The device of claim 1 wherein the second computing device comprises a throughput compute unit.

8. The device of claim 1 wherein enqueuing enables direct access to computational resources.

9. The device of claim 1, wherein the second computing device is a different type than the first computing device.

10. The device of claim 1, wherein the processing unit is heterogeneous.

11. The device of claim 1 wherein the at least one computing task is re-enqueued via at least one of the at least one first computing device queue and the at least one second computing device queue.

12. The device of claim 11 wherein the re-enqueue is enabled with a flag.

13. The device of claim 11 wherein the re-enqueue occurs based on a repetition flag that triggers the number of times the at least one computing task is re-enqueued.

14. The device of claim 13 wherein the repetition field is decremented each time the at least one computing task is re-enqueued.

15. The device of claim 13 wherein the repetition field includes a special value to allow re-enqueuing of the at least one computing task indefinitely.

16. The device of claim 15 wherein the special value is negative one.

17. A computing device, the device comprising:
at least one Heterogeneous System Architecture (HSA) compute unit (H-CU); and
an HSA Memory Management Unit (HMMU) allowing at least one processor of the HSA to communicate with at least one memory,
wherein at least one computing task is enqueued on an HSA-managed queue that is set to run on the at least one processor.

18. The device of claim 17 wherein the at least one computing task is enqueued using a time-based delay queue.

19. The device of claim 17 wherein the at least one computing task is re-enqueued on the HSA-managed queue.

20. The device of claim 19 wherein the re-enqueue occurs based on a repetition flag that triggers the number of times the at least one computing task is re-enqueued.
